(19) United States
(12) Patent Application Publication
(10) Pub. No.: US 2010/0036873 A1
(43) Pub. Date: Feb. 11, 2010

(54) Processing Metadata Along With Alphanumeric Data

(76) Inventor: Richard Bruce Diehl, Clarksville, MD (US)

Correspondence Address: Ashok Tankha, 36 Greenleigh Drive, Sewell, NJ, 08080, US

(21) Appl. No.: 12/185,819

(22) Filed: Aug. 5, 2008

(51) Int. Cl. G06F 7/00; G06F 17/30

(52) U.S. Cl. 707/103 Y; 707/E17.055; 707/E17.048

(57) ABSTRACT

Disclosed herein is a computer implemented method and system for processing metadata associated with alphanumeric data along with the alphanumeric data for tracking effect of operations on the metadata in a data model. Multiple mixed data objects are created in the data model. Each of the created mixed data objects comprises the alphanumeric data and the metadata. The created mixed data objects are stored with information about interrelationships between the created mixed data objects. Multiple operations are performed on the stored mixed data objects to obtain mixed data results. The operations are performed simultaneously on the alphanumeric data and the metadata. The mixed data results comprise results of the operations performed on the alphanumeric data and the metadata. The data model is updated with the obtained mixed data results. The simultaneous operations performed on the alphanumeric data and the metadata enable tracking the effect of the operations on the metadata.

### BACKGROUND

This invention, in general, relates to analytical programs such as online analytical processing (OLAP), databases, and spreadsheets. More particularly, this invention relates to processing metadata associated with alphanumeric data along with the alphanumeric data in analytical programs.

The need to track numbers and techniques for tracking numbers pre-dates the computer era. A simple list of numbers with a sum may be termed as a data model. A data model typically comprises independent data and dependent data. Independent data is data which is input into the data model. For example, the independent data may be a list of numbers to be added. Dependent data is calculated from the independent data within the data model. For example, the dependent data may be the sum of the list of numbers. Independent data is determined from the real world and input into the data model. Data models may become more complex as more equations are added. For example, the sum of the list of numbers may be used as input to another set of equations, making the data model more complex.

Analytical programs are typically used to create complex interrelationships in order to define a data model. The interrelationships may include a series of equations. Solvers used in the analytical programs may then determine the order of solving the series of equations. Solvers may also produce the solution to the data model as a series of final values. Analytical programs enable users to efficiently create data models for problems and receive reliable answers. However, standard analytical programs do not allow a user to attach metadata to the numerical data in a desirable manner so as to transform the metadata accordingly by the series of transformations defined by the solver.

During problem solving, data from the real world is input to the problem. However, data from the real world often has different levels of reliability. With large data models, it may be difficult for users to keep track of estimates, values based on estimates, and final values. Business people commonly label numbers as an estimate or a final number. In a data model, any subsequent value depending on an estimate is marked as an estimate, since a final value is to be determined. However, in standard data models the information on the numerical values is maintained either manually or indirectly.

Metadata may also be useful to businesses for making projections regarding their operations and business finances. Often users may know of uncertainty in a number and may describe the uncertainty by using a range of values that may contain the actual value. Traditional accounting practices make assumptions of the future and build the assumptions into data models of various complexities in order to make predictions of an uncertain nature. Because assumptions are uncertain by nature, better data models attempt to take into account the varying levels of uncertainty posed by the assumptions. Therefore, multiple models with varying levels of uncertainty are created. One approach is to create high and low values for the assumptions, creating a range of possibilities. Thus the user is more certain that the result will fall within the created range. However, creating these models involves a huge amount of effort. The number of data models necessary to create a reliable solution may grow exponentially with the number of variables.

In data models, units of initial values are often known, but the units of the subsequent calculated values may not be known. In simple cases, such as sums of numbers, the resulting units are obvious. But in complex cases, it may be difficult to determine the resulting units. For example, a business may find it difficult to determine the resulting unit while making complex calculations. Typically, metadata is attached to input values or output values. The metadata may not be transformed with the numerical values in a reliable way.

There are many cases where metadata is attached to numerical values, thereby providing utility to the user if the metadata is transformed with the numerical values themselves as part of the solution process. However, the transformations may not be defined uniquely for each type of metadata, and for each operation the numerical value undergoes. One solution to the problem is to work out ahead of time the metadata solutions and assign the solution, by hand, or by automation, to the solution set. This solution may work if the data set comprises a large number of identical pieces of metadata, but may not work if the data set comprises dissimilar metadata. Keeping track of the changes in the metadata becomes difficult because the data model becomes complex. Moreover, in order to ensure that the numerical data and the metadata are both being calculated in the same way, there is a need to calculate the metadata with the numerical data.

Hence, there is a need for combining alphanumeric data and metadata associated with the alphanumeric data and processing the associated metadata with the alphanumeric data to track effect of operations on the metadata in a data model.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein address the above stated need for combining alphanumeric data and metadata associated with the alphanumeric data, and processing the associated metadata with the alphanumeric data to track the effect of operations on the associated metadata in a data model.

Multiple mixed data objects are created in the data model. The data model may comprise the mixed data objects and expressions associated with the mixed data objects. Each of the mixed data objects comprises alphanumeric data and associated metadata. The associated metadata may comprise dimension metadata, range metadata, and estimation metadata. The dimension metadata stores a unit specifier for the alphanumeric data. The range metadata stores a range of numerical values for the numerical data. The estimation metadata stores an indication of the alphanumeric data being an estimate. The mixed data objects may be created using an object oriented programming language. The mixed data objects are stored with information about interrelationships between the created mixed data objects.

Operations are performed on the mixed data objects to obtain mixed data results. The operations are performed simultaneously on the alphanumeric data and the associated metadata. The mixed data results comprise results of the operations performed on the alphanumeric data and the associated metadata. The operations performed on the alphanumeric data may comprise, for example, mathematical operations, logical operations, boolean operations, and text based operations. The data model is updated with the obtained mixed data results.

The creation of the mixed data objects enable combination of the alphanumeric data and metadata associated with the alphanumeric data, and the simultaneous operations performed on the alphanumeric data and the associated metadata enable tracking the effect of the operations on the associated metadata.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of processing metadata associated with alphanumeric data with the alphanumeric data for tracking effect of operations on the associated metadata in a data model.

FIG. 2 illustrates a computer implemented system for processing metadata associated with alphanumeric data with the alphanumeric data for tracking effect of operations on the associated metadata in the data model.

FIG. 3 exemplarily illustrates the structure of a mixed data object.

FIG. 4 exemplarily illustrates a schematic representation of the data model comprising the mixed data objects and expressions associated with the mixed data objects.

FIG. 5 exemplarily illustrates a graphical user interface of a numeric modeling software program displaying a financial balance sheet with indications of estimation metadata in the data model.

FIG. 6 exemplarily illustrates a graphical user interface of a numeric modeling software program displaying a financial balance sheet with indications of estimation metadata and range metadata in the data model.

FIG. 7 exemplarily illustrates components of the computer system used for processing metadata associated with alphanumeric data with the alphanumeric data for tracking effect of operations on the associated metadata.

FIG. 8 exemplarily illustrates a schematic representation of a software system provided on the computer system for processing metadata associated with alphanumeric data with the alphanumeric data for tracking effect of operations on the associated metadata.

### DETAILED DESCRIPTION OF THE INVENTION

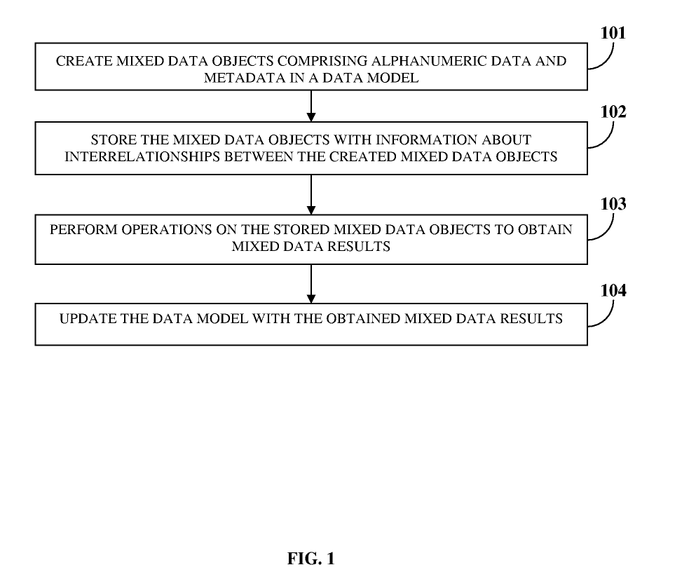

FIG. 1 illustrates a computer implemented method processing metadata 303 associated with alphanumeric data 302 with the alphanumeric data 302 for tracking effect of operations on the associated metadata 303 in a data model 401. The data model 401 may be analytical software such as spreadsheet processing software.

Multiple mixed data objects 401a are created 101 in the data model 401. Each of the created mixed data objects 401a comprises the alphanumeric data 302 and the associated metadata 303. The alphanumeric data 302 comprises numerical data and non numerical data. The metadata 303 may comprise dimension metadata, range metadata, and estimation metadata. The dimension metadata stores a unit specifier for the alphanumeric data 302. The range metadata stores a range of values of the alphanumeric data 302. The estimation metadata stores an indication of the alphanumeric data 302 being an estimate. The created mixed objects 401a comprise mathematical properties similar to the alphanumeric data 302 in the mixed data objects 401a; hence they may be transparent to the data model 401.

New operations may be added specific to the associated metadata 303, which may be used when accessing the data model 401, to input or to retrieve data from the data model 401. In this way, operations performed on the associated metadata 303 can be extended and altered without altering the underlying functionality of the other aspects of the data model 401. A typical existing data model 401 such as analytical software, for example, numeric modeling software may be modified using object oriented technology for compatibility with the mixed data objects 401a. The data model 401 may further comprise expressions 401b associated with the mixed data objects 401a.

The mixed data objects 401a may be created using an object oriented programming language, for example C Sharp (C#). Using the object oriented programming language, a class is created for the mixed data objects 401a which inherits the properties of the alphanumeric data 302. Different classes are also created for the different associated metadata 303. The mixed data objects 401a are made compatible with the programming language used, by overloading operators of the programming language. Most object oriented languages allow overloading of operators, thereby enabling operations to be performed on user defined objects in a user defined manner. The mixed data object class definitions should contain data definitions for both the alphanumeric data 302 and metadata 303, definitions for the necessary operators, constructors, accessor routines for the associated metadata 303, and any other utility routines necessary for proper operation in the environment.

To ensure proper operation of the basic numerical functionality, the mathematical operators in C# must be overloaded to work on the mixed data objects 401a. These overloaded math operators should at minimum return a valid mixed data object 301. This means that at minimum, an underlying operation should be performed on the alphanumeric data 302, and some operation should be performed on the associated metadata 303, or the associated metadata 303 should be initialized to some reasonable value if there is no affect of the operation on the associated metadata 303. In addition to having a complete set of overloads for each math operations, any additional operations on the mixed data objects 401a should perform the proper action on the alphanumeric data 302, and actions on each piece of associated metadata 303. For examples, we must overload the ‘+’ operator. The two alphanumeric values are first ‘added’. Then estimation metadata is then ‘added’. If either number is an estimate, then the mixed data result is an estimate, otherwise the result is final. Then the two ranges are ‘added’. The range of the mixed data result will be the simple addition of the two ranges. Then the two units are ‘added’. If both units are the same, we can add them; otherwise, an error may be returned.

Accessors and constructors may be used to create the mixed data objects 401a. The use of accessors and constructors facilitates data hiding, thereby preventing unintentional modification of data in the mixed data objects 401a. The accessors may be used when data is retrieved from the data model 401 to display certain attributes of the mixed data objects 401a, for example, the alphanumeric data 302 or a part of the associated metadata 303 such as range, estimation, or dimension. The accessors are used to retrieve data from the mixed data objects 401a. The constructors are used for placing alphanumeric data 302 and associated metadata 303 into a mixed data object 301.

Operator overloading is performed for the operators to ensure compatibility of the mixed data objects 401a with the programming language. The operators must return a valid result for both the alphanumeric data 302 and the associated metadata 303 in the mixed data objects 401a after any operation performed on the mixed data objects 401a. For example, the ‘+’ operator may be overloaded for addition of two mixed data objects 401a to obtain a mixed data result. Simple addition may be performed on the alphanumeric data 302. For estimation metadata, an equivalent addition operation is performed by comparing the estimation metadata of the mixed data objects 401a. If the estimation metadata of any one of the mixed data objects 401a indicates that the alphanumeric data 302 is an estimate, the estimation metadata of the mixed data result will indicate that the alphanumeric data 302 in the mixed data result is an estimate.

For range metadata, the ranges of numerical values for the alphanumeric data 302 will be added to obtain the range metadata of the mixed data result. The unit specifiers stored in the dimension metadata of the mixed data objects 401a are compared. If the unit specifers specify the same unit for the mixed data objects 401a, the mixed data objects 401a may be added. If the unit specifers specify different units for the mixed data objects 401a, an error message may be returned. Similarly, operators like ‘+’ (addition), ‘−’ (subtraction), ‘−’ (negative), ‘*’ (multiplication), ‘/’ (division), ‘%’ (remainder), ‘!’ (not), ‘&’ (and), ‘|’ (or), ‘>’ (greater than), ‘<’ (less than), ‘>=’ (greater than or equal to), ‘<=’ (less than or equal to), ‘==’ (equal to), ‘!=’ (not equal to) may be overloaded more than once to perform a greater number of operations.

The mixed data objects 401a must also be defined with accessors for the alphanumeric data 302 and associated metadata 303. Accessors are small functions whose only purpose is to get a particular piece of data from the object. C# is capable of hiding the actual data using a ‘private’ keyword, so it cannot be used except inside the environment. Hiding the actual data ensures that data within the mixed data objects 401a will not be changed improperly, increasing code quality and reducing errors. To place data into an object, constructors are used. This helps ensure that the mixed data objects 401a are properly formed and the associated metadata 303 is coordinated with the alphanumeric data 302.

Other object oriented languages besides C# have a similar operator overload capability and may be used as efficiently. A non-object oriented language may also be used. However, using operator overloading enhances efficiency of implementation. Without operator overloading, expressions 401b such as ‘Result=A+B’ would have to directly call a subroutine which takes the mixed data object 401a, such as ‘Result=Add(A,B)’. In practicality, this would not interfere with the programming. It would merely add to the implementation work.

The mixed data objects 401a must be used in cases where alphanumeric data 302 would be used. If an existing solver and data model 401 are being used, then instances of the alphanumeric data 302 in the data model 401 and the solver 203 are replaced by the associated metadata 303. If a new solver 203 and data model 401 are being developed, then the solver 203 and data model 401 are developed using mixed data objects 401a, rather than the alphanumeric data 302.

Functions may also be defined to perform operations on the alphanumeric data 302 as well as the associated metadata 303. The functions defined to perform operations on the alphanumeric data 302 as well as the associated metadata 303 may, for example, be ‘true’, ‘false’, ‘power’, ‘round’, and ‘ifthenelse’. In the case of ‘ifthenelse’, the underlying operators could be used expressions 401b such as ‘if A then B, else C’ may be directly written. However, this expression would not properly perform error checking to see if A is valid. The function ‘ifthenelse’ performs error checking. When implementing the mixed data objects 401a in C#, it is important to also realize that in many cases, mixed data objects 401a will need to be created which have no data provided, or have only underlying alphanumeric data 302. Therefore, it is important that each metadata 303 have a default value associated with the metadata 303, which is appropriate for any mixed data object 301 which is not explicitly provided data. A constructor may also be used to construct metadata 303 out of base alphanumeric data 302. Functions may also be defined to return mixed data objects 401a having indeterminate alphanumerical data 302 with a defined valid associated metadata 303. The functions defined to return mixed data objects 401a having indeterminate alphanumerical data 302 with a defined valid associated metadata 303 may, for example, be ‘newtrue’, ‘newfalse’, and ‘newindeterminate’.

The created mixed data objects 401a are stored 102 in the data model 401 with information about interrelationships between the created mixed data objects 401a. The interrelationships between the created mixed data objects 401a determine operations to be performed on the stored mixed data objects. The operations may also be performed on the result of the expressions 401b. The expressions 401b may or may not be part of the data model 401.

Multiple operations are performed 103 on the stored mixed data objects to obtain mixed data results. The operations to be performed may be, for example, mathematical operations, logical operations, boolean operations, and text based operations. The operations may be determined using interrelationships between the created mixed data objects 401a. The operations are performed simultaneously on the alphanumeric data 302 and the associated metadata 303 in the mixed data objects 401a. The mixed data results comprise results of the operations performed on the alphanumeric data 302 and the associated metadata 303. For example, if an operation is to be performed on two mixed data objects 401a using an overloaded operator ‘+’, the mixed data result will comprise result of the simple addition performed on the alphanumeric data 302, and result of the equivalent addition operation performed on the associated metadata 303.

The operations are performed on the associated metadata 303 based on the class of the associated metadata 303. Each of the overloaded operators performs different operations on the different classes of the associated metadata 303, based on the classes of the associated metadata 303. For estimation metadata, a predefined code is placed within an operator overloaded function of the object oriented language to operate on the estimation metadata. By default, the estimation metadata in the created mixed data objects 401a indicates that the alphanumeric data 302 is not an estimate, unless the alphanumeric data 302 is specified as an estimate during creation of the mixed data objects 401a. For the operations except the ‘ifthenelse’ function, if the estimate metadata in any one of input mixed data objects 401a indicates that the alphanumeric data 302 is an estimate, the estimation metadata of the mixed data result will indicate that the alphanumeric data 302 in the mixed data result is an estimate. For the ‘ifthenelse’ function comprising a selected operand and an ignored operand, if the selected operator of the “ifthenelse” statement is an estimate then the output is an estimate.

For the range metadata, second alphanumeric data is stored within the mixed data object 301. The second alphanumeric data is herein referred to as a deviation. The deviation represents the difference between an upper boundary or a lower boundary of the range and the alphanumeric data 302. The deviation may be zero or a positive value.

If the difference between the upper boundary and the alphanumeric data 302 is not equal to the difference between the lower boundary and the alphanumeric data 302, more than one different deviation values may be stored. One deviation value may be stored to represent the difference between the upper boundary and the alphanumeric data 302, and one deviation value may be stored to represent the difference between the lower boundary and the alphanumeric data 302. Alternatively, a single deviation may be calculated and the alphanumeric data 302 may be modified accordingly to store a value in the center of the range.

For the overloaded ‘+’ (addition) operation and ‘−’ (subtraction) operation performed on the range metadata, the deviation of the mixed data result is a sum of the deviations of the mixed data objects 401a used as operands. For overloaded ‘*’ (multiplication) operation, a brute force approach is used. Multiple values are calculated for computing the deviation of the mixed data result. The multiple values are calculated by performing the following operations: operand 1 min*operand 2 min, operand 1 min*operand 2 max, operand 1 max*operand 2 min, and operand 1 max*operand 2 max. As used herein, operand 1 min is the lower boundary of a first mixed data object, operand 2 min is the lower boundary of a second mixed data object, operand 1 max is the upper boundary of the first mixed data object, and operand 2 max is the upper boundary of the second mixed data object. The minimum value and maximum value obtained from the preceding operations are used to calculate the deviation of the mixed data result. The deviation of the mixed data result is calculated using the equation, ‘deviation=½(maximum value−minimum value)’.

For overloaded ‘/’ (division) operation on the range metadata also, the brute force approach is used. Multiple values are calculated for computing the deviation of the mixed data result. The multiple values are calculated by performing the following operations: operand 1 min/operand 2 min, operand 1 min/operand 2 max, operand 1 max/operand 2 min, and operand 1 max/operand 2 max. As used herein, operand 1 min is the lower boundary of a first mixed data object, operand 2 min is the lower boundary of a second mixed data object, operand 1 max is the upper boundary of the first mixed data object, and operand 2 max is the upper boundary of the second mixed data object. The minimum value and maximum value obtained from the preceding operations are used to calculate the deviation of the mixed data result. The deviation of the mixed data result is calculated using the equation, ‘deviation=½(maximum value−minimum value)’.

The ‘%’ (remainder) operation may be overloaded to return an error for the range metadata. Typically, on usage of the range of values, there is a smooth transition between one intermediate value and the subsequent value. However, for the remainder function, the intermediate values are often step functions. For overloaded ‘−’ (negative) operation and overloaded ‘!’ (not) operation, the deviation may not change. For overloaded ‘round’ operation, the deviation may be rounded. For boolean operators, a number greater than zero is defined as a true value, and a number less than or equal to zero is defined as a false value. Therefore, the range metadata may have one of three values, true, false, or indeterminate. The three values may be displayed to a user 205. For example, if the alphanumeric data 302 is 10, with a deviation of 20 defined in the range metadata, the lower boundary of the range is −10 and the upper boundary of the range is 30. The value −10 is a false value, while the value 30 is a true value. A range having a lower boundary less than or equal to 0, and an upper boundary greater than zero, may be called an indeterminate range. A function may be defined for creating an indeterminate number, 0, with a deviation of 1. A numerical value, interpreted as a boolean operator may be true, false, or indeterminate.

The operators ‘&’ (and), ‘|’ (or), ‘>’ (greater than), ‘<’ (less than), ‘>=’ (greater than equal to), ‘<=’ (less than equal to), ‘==’ (equal to), ‘!=’ (not equal to), “true”, “false”, and “ifthenelse” are interpreted as boolean operators. If the result is indeterminate, the alphanumeric data 302 is set to 0 and the deviation is set to 1. In other cases, the alphanumeric data 302 is set to either true (1) or false (0) and the deviation is set to 0.

For the dimension metadata, the unit specifiers are stored as integers. A first set of unit specifiers are stored for the numerator for a mixed data object 301. A second set of unit specifiers are stored for the denominator for a mixed data object 301. The multiple unit specifiers in the mixed data object 301 enables usage of complex units, for example foot pound per second. By default, the first set of unit specifiers and the second set of unit specifiers are empty.

For overloaded ‘+’ (addition) and overloaded ‘−’ (subtraction) operations on the dimension metadata, if the mixed data objects 401a used as operands have the matching sets of unit specifiers for both numerator and denominator, the mixed data result will have the same set of unit specifiers as the mixed data objects 401a. If the mixed data objects 401a used as operands have the dissimilar sets of unit specifiers for both the numerator and the denominator, an error is returned.

For overloaded ‘*’ (multiplication) operation on the dimension metadata, unit specifiers of numerators of the mixed data objects 401a used as operands are added, and unit specifiers of denominators of the mixed data objects 401a used as operands are added. Unit specifiers appearing in the sets of unit specifiers of more than one of the mixed data objects 401a used as operands are added as many times as they appear. Hence, complex units such as foot per second-second may be used.

For overloaded ‘/’ (division) operation and overloaded ‘%’ (remainder) operation on the dimension metadata using two mixed data objects 401a as a first operand and a second operand, the unit specifier of the numerator of the mixed data result is equal to the sum of unit specifiers in numerator of the first operand and the unit specifiers in denominator of the second operand. The unit specifier of the denominator of the mixed data result is equal to the sum of unit specifiers in the denominator of the first operand and the unit specifiers in the numerator of the second operand.

For overloaded unary operations such as ‘−’ (negative), “round”, and ‘!’ (not) on the dimension metadata, the unit specifiers may not change. For overloaded boolean operators such as ‘&’ (and), ‘|’ (or), ‘>’ (greater than), ‘<’ (less than), ‘>=’ (greater than or equal to), ‘<=’ (less than or equal to), ‘==’ (equal to), ‘!=’ (not equal to), “true”, and “false” the mixed data result does not have a unit specifier. For the overloaded “IfThenElse” statement comprising a selected operand and an ignored operand, the unit specifier of the mixed data result is the same as the unit specifier of the selected operand.

For overloaded ‘power’ operation on the dimension metadata, if a second operand is not an integer, the dimension metadata of the mixed data result may not comprise a unit specifier. If the second operand is positive, the numerator and the denominator input lists are added to the output based on numerality of the integer. For example, if the second operand is 3 and the unit of the input numerator is second, the unit of the output numerator would be second. If the second operand is negative, the unit of the input numerator is used to set the unit of the output denominator and the unit of the input denominator is used to set the unit of the output numerator. The number of unit specifiers used may be limited. The set of unit specifiers may comprise a number associated with each unit specifier to determine how many times each unit specifier is used. Limiting the number of unit specifiers keeps the size of the set of unit specifiers within an acceptable limit. If the number of unit specifiers is not limited, the unit specifiers may be set to zero and an error may be returned.

The data model 401 is updated 104 with the mixed data results obtained from the operations performed on the stored mixed data objects. The mixed data results comprise both alphanumeric data 302 and associated metadata 303. The alphanumeric data 302 in the mixed data result is the result of the operations performed on the alphanumeric data 302 of the stored mixed data objects. The associated metadata 303 in the mixed data result is the result of the operations performed on the associated metadata 303 of the stored mixed data objects.

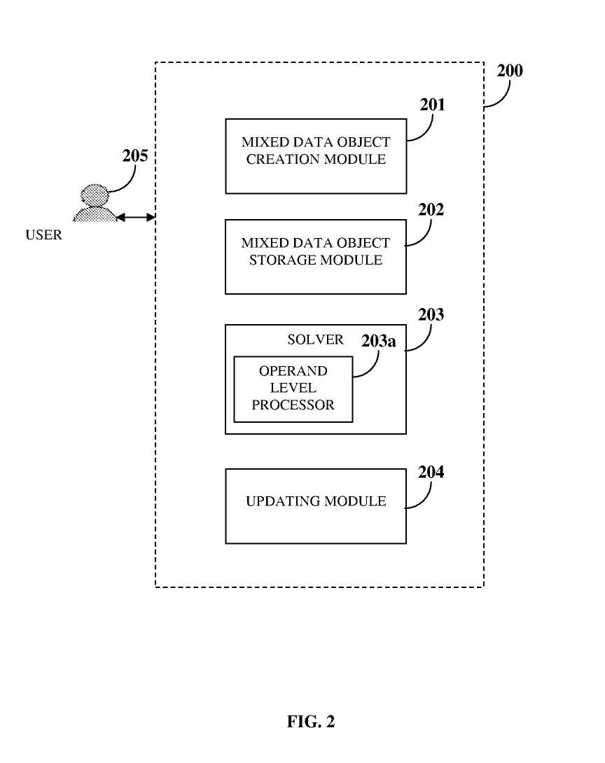

FIG. 2 illustrates a computer implemented system 200 for processing metadata 303 associated with alphanumeric data 302 with the alphanumeric data 302 for tracking effect of operations on the associated metadata 303 in the data model 401. The system 200 disclosed herein comprises a mixed data object creation module 201, a mixed data object storage module 202, a solver 203, and an updating module 204. The solver 203 comprises an operand level processor 203a.

The mixed data object creation module 201 creates the mixed data objects 401a in the data model 401. Each of the created mixed data objects 401a comprises the alphanumeric data 302 and the associated metadata 303. The mixed data object creation module 201 may create the mixed data objects 401a using an object oriented programming language, for example, C#. A class is created for the mixed data objects 401a which inherits the properties of the alphanumeric data 302. Different classes are also created for the different associated metadata 303. The mixed data object creation module 201 may use accessors and constructors to create the mixed data objects 401a. The use of accessors and constructors facilitates data hiding, hence preventing unintentional modification of data in the mixed data objects 401a. The accessors may be used when data is retrieved from the data model 401 to display select attributes of the mixed data objects 401a, for example, the alphanumeric data 302 or a part of the associated metadata 303 such as range, estimation, or dimension. The accessors are used to retrieve data from the mixed data objects 401a. The constructors are used for placing alphanumeric data 302 and associated metadata 303 into a mixed data object 401a.

The mixed data object storage module 202 stores the created mixed data objects 401a with information about interrelationships between the created mixed data objects 401a. The solver 203 performs the operations on the stored mixed data objects to obtain mixed data results. The solver 203 performs the operations simultaneously on the alphanumeric data 302 and the associated metadata 303. The solver 203 obtains mixed data results comprising both alphanumeric data 302 and associated metadata 303. The alphanumeric data 302 in the mixed data result is the result of the operations performed on the alphanumeric data 302 of the stored mixed data objects. The associated metadata 303 in the mixed data result is the result of the operations performed on the associated metadata 303 of the stored mixed data objects. The solver 203 performs operations on the mixed data objects 401a based on the interrelationships between the created mixed data objects 401a and the expressions 401b in the data model 401.

The operand level processor 203a in the solver 203 performs the operations on an operand by operand basis. The operand level processor 203a performs the operations on each of the alphanumeric data 302 and the associated metadata 303 separately. The operand level processor 203a performs the operations on the associated metadata 303 based on the class of the associated metadata 303. For example, the operand level processor 203a may perform the operations on estimation metadata differently from the operations on range metadata. The solver 203 may be obtained by modifying an existing solver used in solving equations involving purely numerical data. The updating module 204 updates the data model 401 with the obtained mixed data results.

The solver 203 uses the interrelationships between the created mixed data objects 401a and the expressions 401b to determine order of the operations to be performed on the mixed data objects 401a and the expressions 401b in the data model 401. For non recursive interrelationships, the solver 203 performs operations on mixed data objects 401a and expressions 401b that depend on constants and predetermined values. For complex recursive interrelationships, the solver 203 may employ advanced methods for performing the operations. For example, the solver 203 may maintain a resolved flag stored within the mixed data object 301, to indicate if the operations have been performed on the mixed data object 301. The solver 203 determines which mixed data objects 401a and expressions 401b the operations need to be performed on. The solver 203 may also be an unmodified solver as typically used in current analytical software. A person skilled in the art can create the solver 203 in the data model 401 using currently available technology.

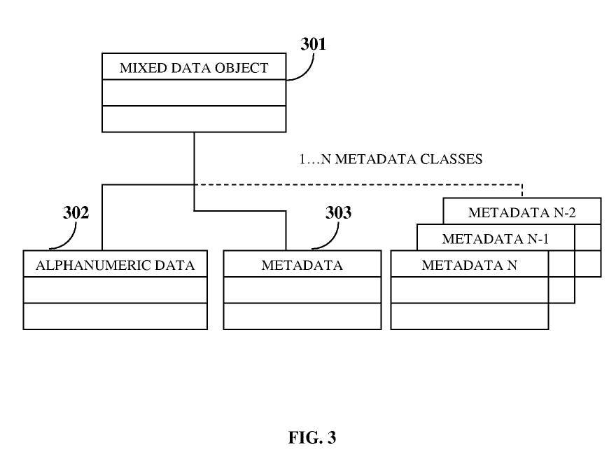

FIG. 3 exemplarily illustrates the structure of a mixed data object 301. The mixed data object 301 comprises alphanumeric data 302 and associated metadata 303. There may be multiple associated metadata 303 classes, for example, estimation metadata, range metadata, and dimension metadata. The mixed data object 301 is created by the mixed data object creation module 201. The mixed data object 301 may be created using accessors and constructors of an object oriented programming language. Using the object oriented programming language, the mixed data object 301 is created as a class which inherits the properties of the alphanumeric data 302.

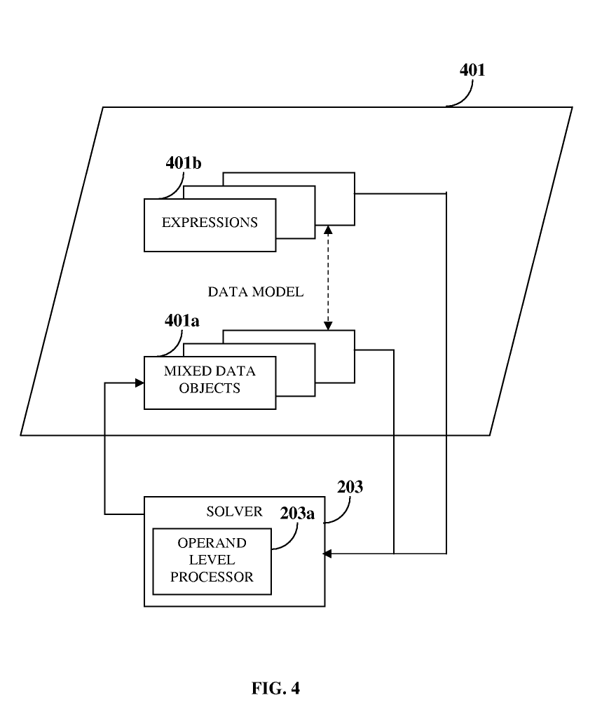

FIG. 4 exemplarily illustrates a schematic representation of the data model 401 comprising the mixed data objects 401a and expressions 401b associated with the mixed data objects 401a. Each of the mixed data objects 401a comprising alphanumeric data 302 and associated metadata 303 are processed by the solver 203. The solver 203 performs operations on the alphanumeric data 302 and the metadata 303 associated with the alphanumeric data 302. Operations on the associated metadata 303 are performed by an operand level processor 203a to obtain mixed data results. The mixed data object result comprises the result of the operations performed on the alphanumeric data 302 and the associated metadata 303.

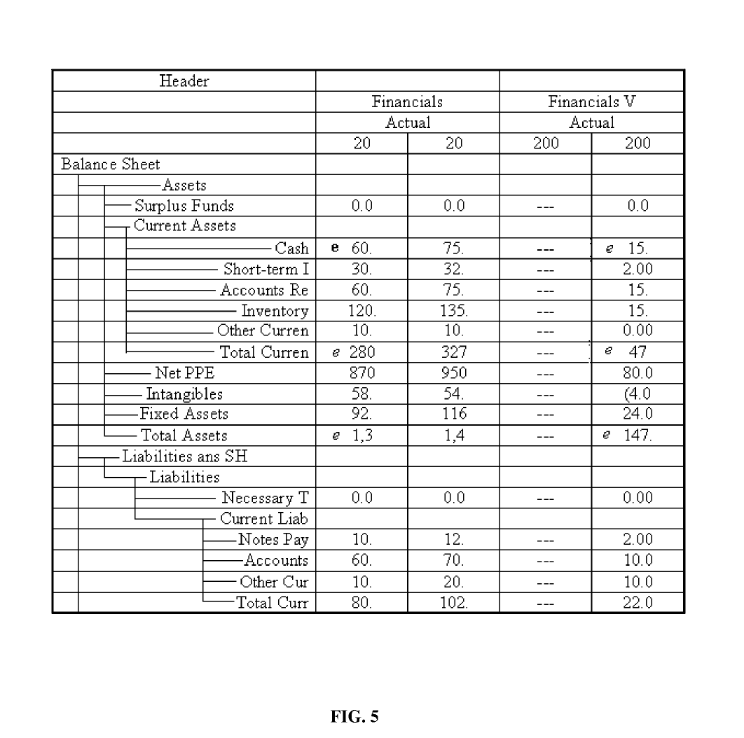

FIG. 5 exemplarily illustrates a graphical user interface (GUI) 802 of a numeric modeling software program displaying a financial balance sheet with indications of estimation metadata in the data model 401. The numeric modeling software program is modified to use the mixed data objects 401a containing estimation metadata. A single mixed data object 301 is set to be an initial estimate. The initial estimate is indicated in the FIG. 5 by a bold ‘e’. The solver 203 computes other mixed data objects 401a in the data model 401 based on the initial estimate. The computed mixed data objects 401a are dependent estimates, since the values of the computed mixed data objects 401a are dependent on the initial estimate mixed data object 301. Each one of the dependent estimates is indicated in the FIG. 5 by an italic ‘e’. The solver 203 calculates the effect on the initial estimate by using a set of modified calculations. The modified calculations are performed on both the alphanumeric data 302 and the associated metadata 303 in the mixed data object 301.

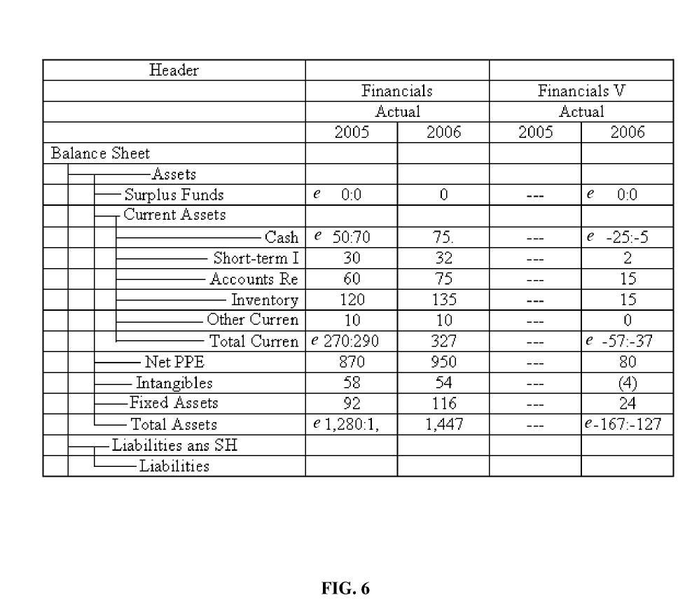

FIG. 6 exemplarily illustrates a graphical user interface (GUI) 802 of a numeric modeling software program displaying a financial balance sheet with indications of estimation metadata and range metadata in the data model 401. The numeric modeling software program is modified to use the mixed data objects 401a comprising both estimation metadata and range metadata. A single mixed data object 301 is set to have an initial range metadata and an initial estimation metadata. Seven mixed data objects 401a depend on the initial range metadata or the initial estimation metadata. The dependent range metadata is not visually differentiated from the initial range metadata in FIG. 6 as the data model 401 requires a recursive calculation to be performed. The initial estimation metadata and the dependent estimation metadata are indicated by an italic ‘e’. The initial range metadata and the dependent range metadata are indicated by a colon (:) symbol, for example 50:70. The initial range metadata and the initial estimation metadata may be calculated more than once.

The range metadata may also be displayed in plus minus format or percent range format. For example, if the range metadata has lower boundary 50 and upper boundary 150, the range metadata may be displayed as ‘100+−50’ in the plus minus format. The range metadata may also be displayed as ‘100+−50%’ in the percent range format. Furthermore, the range metadata may also be displayed in a color format. The lower boundary and the upper boundary of the range metadata may be displayed in different colors, for example, the lower boundary may be displayed in blue, and the upper boundary may be displayed in green.

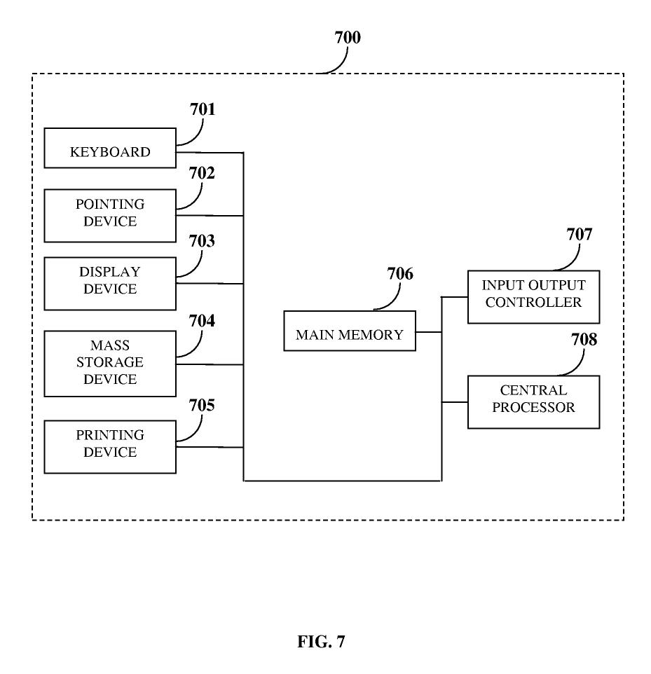

FIG. 7 exemplarily illustrates components of a computer system 700 used for processing metadata 303 associated with alphanumeric data 302 with the alphanumeric data 302 for tracking effect of operations on the associated metadata 303. The computer system 700 comprises a central processor 708, a main memory 706, an input output controller 707, a keyboard 701, a pointing device 702, a display device 703, and a mass storage device 704. Additional input devices and output devices, for example a printing device 705, may also be included as a part of the computer system 700. The components of the computer system 700 communicate via a system bus or similar architecture. The computer system 700 may, for example, be an IBM® compatible personal computer, available from several vendors, for example, Dell™ Inc.

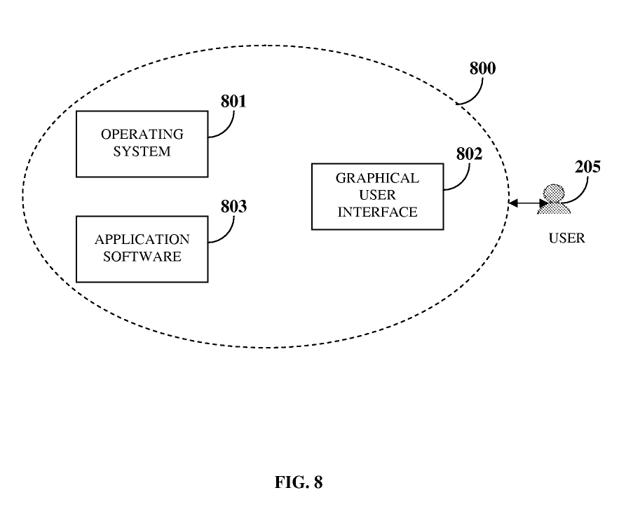

FIG. 8 exemplarily illustrates a schematic representation of a software system 800 provided on the computer system 700 for processing associated metadata 303 associated with alphanumeric data 302 with the alphanumeric data 302 for tracking effect of operations on the associated metadata 303. The software system 800 stored on the main memory 706 and on the mass storage device 704 comprises a kernel or operating system 801 and a shell or a GUI 802. Application software 803 may be loaded or transferred from the mass storage device 704 into the main memory 706 for execution by the computer system 700. The computer system 700 receives commands and data from a user 205 through the GUI 802. The received user commands and data may be processed by the computer system 700 in accordance with instructions received via the operating system 801 and the application software 803 The GUI 802 further displays results, whereupon the user 205 may supply additional inputs or terminate the session. In the computer implemented method and system 200 disclosed herein, the operating system 801 may be Microsoft® Windows Vista available from Microsoft® Corporation.

The computer implemented method and system 200 disclosed herein may be embodied in a database application operative in the Microsoft® Vista environment. The present invention, however, is not limited to any particular application or any particular environment. Instead, those skilled in the art will understand that the method and system 200 of the present invention may be advantageously applied to a variety of systems and application software 803, including database management systems, OLAP servers, spreadsheets and the like. Moreover, the present invention may be embodied on a variety of platforms, for example, Windows, Macintosh, UNIX®, etc.

Since other modifications and changes varied to fit particular operating requirements and environments will be apparent to those skilled in the art, the invention is not considered limited to the example chosen for purposes of disclosure, and covers the changes and modifications which do not constitute departures from the true spirit and scope of this invention.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of processing metadata associated with alphanumeric data along with said alphanumeric data for tracking effect of operations on said associated metadata in a data model, comprising the steps of:
creating a plurality of mixed data objects in said data model, wherein each of said created mixed data objects comprises the alphanumeric data and the associated metadata;
storing the created mixed data objects with information about interrelationships between the created mixed data objects in the data model;
performing a plurality of operations on said stored mixed data objects to obtain mixed data results, wherein said operations are performed simultaneously on the alphanumeric data and the associated metadata, further wherein said mixed data results comprise results of the operations performed on the alphanumeric data and the associated metadata; and
updating the data model with said obtained mixed data results;
whereby said simultaneous operations performed on the alphanumeric data and the associated metadata enable tracking of said effect of the operations on the associated metadata.

2. The computer implemented method of claim 1, wherein the associated metadata comprises dimension metadata, wherein said dimension metadata stores a unit specifier for the alphanumeric data.

3. The computer implemented method of claim 1, wherein the associated metadata comprises range metadata, wherein said range metadata stores a range of alphanumeric values for the alphanumeric data.

4. The computer implemented method of claim 1, wherein the associated metadata comprises estimation metadata, wherein said estimation metadata stores an indication of the alphanumeric data being an estimate.

5. The computer implemented method of claim 1, wherein the operations are determined using said interrelationships between the created mixed data objects.

6. The computer implemented method of claim 1, wherein the data model comprises the mixed data objects and expressions associated with the mixed data objects.

7. The computer implemented method of claim 1, wherein the operations comprise mathematical operations, logical operations, boolean operations, and text based operations.

8. A computer implemented system for processing metadata associated with alphanumeric data along with said alphanumeric data for tracking effect of operations on said associated metadata in a data model, comprising:
a mixed data object creation module for creating a plurality of mixed data objects in said data model, wherein each of said created mixed data objects comprises the alphanumeric data and the associated metadata;
a mixed data object storage module for storing the created mixed data objects with information about interrelationships between the created mixed data objects;
a solver for performing a plurality of operations on said stored mixed data objects to obtain mixed data results, wherein the solver performs said operations simultaneously on the alphanumeric data and the associated metadata; and
an updating module for updating the data model with said obtained mixed data results.

9. The computer implemented system of claim 8, wherein said solver comprises an operand level processor for performing the operations on the associated metadata in the stored mixed data objects.

10. A computer program product comprising computer executable instructions embodied in a computer readable medium, wherein said computer program product comprises:
a first computer parsable program code for creating a plurality of mixed data objects in a data model, wherein each of said created mixed data objects comprises alphanumeric data and metadata associated with said alphanumeric data;
a second computer parsable program code for storing the created mixed data objects with information about interrelationships between said created mixed data objects;
a third computer parsable program code for performing a plurality of operations on said stored mixed data objects to obtain mixed data results; and
a fourth computer parsable program code for updating said data model with said mixed data results.
